(19) United States
(12) Patent Application Publication
(10) Pub. No.: US 2017/0142333 A1
(43) Pub. Date: May 18, 2017

(54) Background-Running Image Capture Method and Image Capture Apparatus

(71) Applicant: NUBIA TECHNOLOGY CO., LTD., Shenzhen City (CN)

(72) Inventor: Tanwen HUANG, Shenzhen City (CN)

(73) Assignee: NUBIA TECHNOLOGY CO., LTD., Shenzhen City (CN)

(21) Appl. No.: 15/322,141

(22) PCT Filed: Jun. 5, 2015
(86) PCT No.: PCT/CN2015/080900

§ 371 Date: Dec. 26, 2016

(30) Foreign Application Priority Data
Jun. 25, 2014 (CN) 201410293327.2

(51) Int. Cl. H04N 5/232

(52) U.S. Cl. CPC H04N 5/23241; H04N 5/23245; H04N 5/23293

(57) ABSTRACT

A background-running image capture method and image capture apparatus, the background-running image capture method including setting up a background-running image capture mode, and, on the basis of the background-running image capture mode, controlling the activation, operation, and closing of a camera module in the background. The entire image capture process is automatically implemented, and the camera module runs in the background, so the current display interface is not occupied and the user can view, edit, and share captured photographs and videos in real-time, and can also use other applications or functions, saving effort for the user. In addition, in the background-running image capture process, the camera module is activated and closed by various policies, preventing the camera module from continuing to run in the background and thereby cause unnecessary energy loss, thus reducing power consumption and saving energy.

### CROSS-REFERENCE TO RELATED APPLICATION

This application is the U.S. national phase of PCT Appln. No. PCT/CN2015/080900 filed Jun. 5, 2015 which claims priority to Chinese Application No. 201410293327.2 filed Jun. 25, 2014, the disclosures of which are incorporated in their entirety by reference herein.

### TECHNICAL FIELD

The disclosure relates to the field of camera shooting technology, and in particular, to a background shooting method and shooting apparatus.

### BACKGROUND

Shooting functions almost become the essential functions of a variety of terminal devices, including cameras dedicated to take a photograph, camcorders etc., and also including computers, mobile phones etc. In order to meet the requirements of users, shooting functions are getting rich, and there is currently a background shooting function. The background shooting is to control a camera module to run in the background through a background service, and a current display interface is not occupied, so that a user can use other functions while performing shooting, which largely enhances users' satisfaction.

However, during background shooting, the camera module always runs in the background no matter whether the camera module is performing shooting or waiting for shooting, which results in continuous power consumption and rapid increase of power consumption. In practice, during background shooting, the real time of shooting is short, and the most time is used to wait for shooting. Therefore, the most power consumption is consumed by continuous running of the camera module when waiting for shooting, which thus results in a large waste of power.

### SUMMARY

A main purpose of the disclosure is to provide a background shooting method and shooting apparatus, to reduce power consumption for background shooting and save electric energy.

In order to achieve the above purpose, the following technical solutions are used.

A background shooting method includes steps of:

setting a background shooting mode; and

controlling a camera module to start, run and close in the background according to the background shooting mode.

Alternatively, the background shooting mode is a power saving preference mode, and

the step of controlling a camera module to start, run or close in the background according to the background shooting mode includes:

after detecting a preset operation instruction, controlling the camera module to start and run in the background; and

closing the camera module when the camera module completes shooting, and starting the camera module when shooting again.

Alternatively, the background shooting mode is a delay closing mode, and

the step of controlling a camera module to start, run or close in the background according to the background shooting mode includes:

after detecting a preset operation instruction, controlling the camera module to start and run in the background; and

when detecting that there is no shooting instruction in a preset time, closing the camera module.

Alternatively, the step of when detecting that there is no shooting instruction in a preset time, closing the camera module includes:

after the camera module is started, if no shooting instruction is received over the preset time, closing the camera module; or

after the camera module completes shooting, if no shooting instruction is received over the preset time, closing the camera module.

Alternatively, the background shooting mode is a timing shooting mode, and

the step of controlling a camera module to start, run or close in the background according to the background shooting mode includes:

after detecting that a first preset time point is reached, controlling the camera module to start and perform shooting in the background; and

after detecting that a second preset time point is reached, closing the camera module.

Alternatively, the first preset time point is a time point of starting the camera module, and the second preset time point is a time point of closing the camera module.

Alternatively, the background shooting mode is an interval shooting mode,

the step of controlling a camera module to start, run or close in the background according to the background shooting mode includes:

controlling the camera module to complete an action of starting, shooting and closing once in the background at preset intervals.

Alternatively, the method further includes: presetting a time interval to the last shooting or the closing of the camera module.

Alternatively, the method further includes: presetting a time point, and after reaching the time point, automatically starting interval shooting; or a user starting the camera module by means of a functional key or a preset gesture action to start interval shooting.

Alternatively, the method further includes: judging whether a condition of ending interval shooting is reached in the shooting process, and ending shooting upon the condition of ending interval shooting is reached.

Alternatively, the condition of ending interval shooting refers to that a time point of interval shooting reaches a preset time point or duration of ending interval shooting or a number of interval shooting reaches a preset number of interval shooting.

Alternatively, the step of controlling a camera module to start, run and close in the background includes:

after controlling the camera module to start in the background, performing shooting or waiting for shooting in the background, herein the entire process of the camera module is implemented in the background, and a current display interface of a shooting apparatus where the camera module is located is not occupied.

A shooting apparatus includes a setting module, a camera module and a background controlling module, herein,

the setting module is arranged to set a background shooting mode; and

the background controlling module is arranged to control the camera module to start, run and close in the background according to the background shooting mode.

Alternatively, the background shooting mode is a power saving preference mode, and

the background controlling module is arranged to control the camera module to start, run or close in the background according to the background shooting mode by means of:

after detecting a preset operation instruction, controlling the camera module to start and run in the background; and

once the camera module completes shooting, closing the camera module and waiting for starting the camera module again during the next shooting.

Alternatively, the background shooting mode is a delay closing mode, and

the background controlling module is arranged to control the camera module to start, run or close in the background according to the background shooting mode by means of:

after detecting a preset operation instruction, controlling the camera module to start and run in the background; and

when detecting that there is no shooting instruction in a preset time, closing the camera module.

Alternatively, the background controlling module is arranged to close the camera module when detecting that there is no shooting instruction in a preset time by means of:

after the camera module is started, if no shooting instruction is received over the preset time, closing the camera module; or

after the camera module completes shooting, if no shooting instruction is received over the preset time, closing the camera module.

Alternatively, the background shooting mode is a timing shooting mode, and

the background controlling module is arranged to control the camera module to start, run or close in the background according to the background shooting mode by means of:

after detecting that a first preset time point is reached, controlling the camera module to start and perform shooting in the background; and

after detecting that a second preset time point is reached, closing the camera module.

Alternatively, the background shooting mode is an interval shooting mode, and

the background controlling module is arranged to control the camera module to start, run or close in the background according to the background shooting mode by means of:

controlling the camera module to complete an action of starting, shooting and closing once in the background at preset intervals.

Alternatively, the setting module is further arranged to preset a time interval to the last shooting or the closing of the camera module.

Alternatively, the setting module is further arranged to preset a time point of starting interval shooting; and

the background controlling module is arranged to control the camera module to start interval shooting by: after reaching the time point, controlling the camera module to start interval shooting; or after a user presses down a functional key or after a preset gesture action, controlling the camera module to start interval shooting.

Alternatively, the background controlling module is arranged to control the camera module to end interval shooting by: judging whether a condition of ending interval shooting is reached in the shooting process, and if the condition of ending interval shooting is reached, controlling the camera module to end shooting.

Alternatively, the condition of ending interval shooting refers to that a time point of interval shooting reaches a preset time point or duration of ending interval shooting or a number of interval shooting reaches a preset number of interval shooting.

Alternatively, the background controlling module is arranged to control the camera module to start, run and close in the background by means of:

after controlling the camera module to start in the background, performing shooting or waiting for shooting in the background, herein the entire process of the camera module is implemented in the background, and a current display interface of the shooting apparatus where the camera module is located is not occupied.

A computer program includes program instructions, when being implemented by a computer, cause the computer to implement any one of the above background shooting methods.

A carrier having the computer program carried thereon.

With the background shooting method according to the technical solutions of the disclosure, during background shooting, a camera module can be automatically controlled to start, run and close in the background according to a background shooting mode. As the entire shooting process is automatically implemented, and the camera module runs in the background, a current display interface is not occupied and a user can view, edit and share pictures and videos which are taken in real time, and can also use other applications or functions, so that the user saves more time and money. In addition, in the background shooting process, the camera module is started or closed by means of various policies, which prevents unnecessary electrical energy loss resulting from the camera module continuously running in the background, thereby reducing power consumption and saving electrical energy.

### BRIEF DESCRIPTION OF DRAWINGS

FIG. 1 is a flowchart of a first embodiment of a background shooting method according to the disclosure;

FIG. 2 is a flowchart of a second embodiment of the background shooting method according to the disclosure;

FIG. 3 is a flowchart of a third embodiment of the background shooting method according to the disclosure;

FIG. 4 is a flowchart of a fourth embodiment of the background shooting method according to the disclosure; and

FIG. 5 is a structural block diagram of an embodiment of a shooting apparatus according to the disclosure.

The realization of the purpose, the functional features and advantages of the disclosure will be further described in conjunction with embodiments with reference to accompanying drawings.

### DETAILED EMBODIMENTS OF THE DISCLOSURE

It should be understood that the specific embodiments described here are merely used to explain the disclosure instead of limiting the disclosure.

With the background shooting method according to the embodiment of the disclosure, the shooting apparatus presets a background shooting mode, and then controls a camera module to start, run or close in the background according to the background shooting mode. The background shooting mode includes a power saving preference mode, a delay closing mode, a timing shooting mode, an interval shooting mode etc., and the running of the camera module refers to a process of the camera module waiting for shooting and performing shooting after being started. As the entire shooting process is implemented in the background, and a current display interface of the shooting apparatus is not occupied, in the background shooting process, the use of other functions of the shooting apparatus by a user is not influenced.

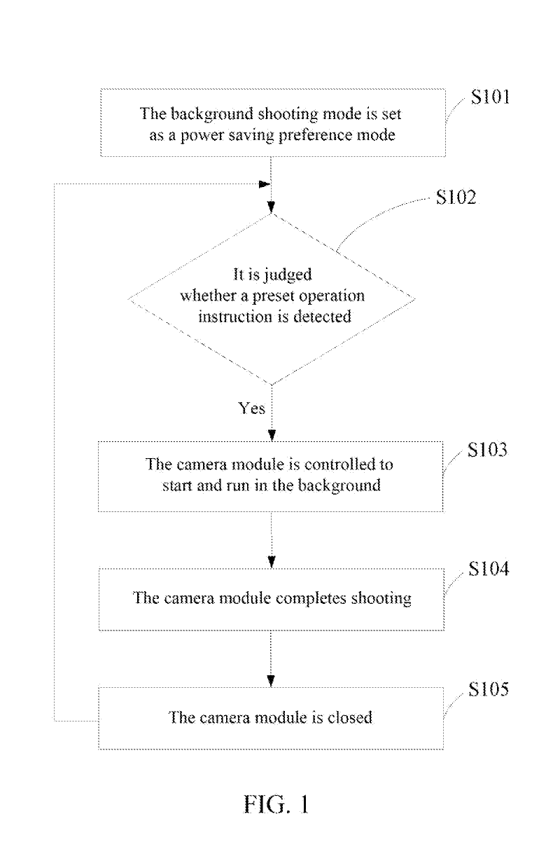

With reference to FIG. 1, a first embodiment of a background shooting method according to the disclosure is proposed. The background shooting method includes the following steps.

In step S101, the background shooting mode is set as a power saving preference mode.

In step S102, it is judged whether a preset operation instruction is detected.

The operation instruction is for example a camera starting instruction, a shooting instruction etc., and may be issued by a preset gesture action or a functional key.

In step S103, the camera module is controlled to start and run in the background.

After receiving the operation instruction, the shooting apparatus then starts the camera module in the background, and the camera module runs in the background, a current real interface is not occupied, and a user can continue to operate other applications of the shooting apparatus and use other functions.

Specifically, by taking an Android system as an example, in a normal shooting mode, shooting and previewing are implemented by an Activity component, herein the Activity is an application program component, which provides a screen or an interaction interface to complete a certain task by interaction with a user. All operations in the Activity are closely related to the user, and the Activity is a component which is responsible for interaction with the user, and can display a specified control through setContentView(View). In an Android application, one Activity is generally an independent screen, and some controls may be displayed on the screen and events of the user may be monitored and processed on the screen to make a response. Communication is implemented between Activities through Intent.

In the background shooting mode, the camera module in the activity is closed, and a current interface is not displayed again as a shooting interface. The shooting apparatus turns to run in the background service by the background controlling module controlling the camera module, and meanwhile uses a setPreviewTexture( ) interface which is built in the camera module. The required parameter SurfaceTexture therein can be created randomly. As a preview picture needs not to be displayed, the created class needs not to be processed, and thereby the shooting function of the camera module can continue to be used.

In step S103, the camera module completes shooting.

After the camera module is started, the camera module performs shooting according to a shooting instruction, for example, implementing camera shooting or taking a picture.

Specifically, when the preset key is triggered, although it cannot be responded in the background service, there is a response in the PhoneWindowManager of the framework layer in the original place where the triggering event occurs. Therefore, when the shooting apparatus detects that the preset key is triggered through the background controlling module, a broadcast is issued according to the triggering event, to use the broadcast Intent as a response event to be received by the camera module which runs in the background. A broadcast receiver is pre-registered in the camera module, and the broadcast can be received by the receiver to obtain the triggering event and implement the triggering event as a shooting instruction, for example, taking a picture, starting video shooting, ending video shooting etc.

In step S104, the camera module is closed.

After camera shooting is completely implemented or a picture is completely taken, the shooting apparatus then closes the camera module and the process returns to step S102, i.e., the background service of the shooting apparatus waits for the next shooting, and when an operation instruction is detected, the camera module is started again to perform shooting.

Thereby, the camera module is closed during each shooting and starting it again during the next shooting to perform shooting, thereby preventing unnecessary electrical energy loss resulting from the camera module continuously running in the process of waiting for shooting and saving electrical energy.

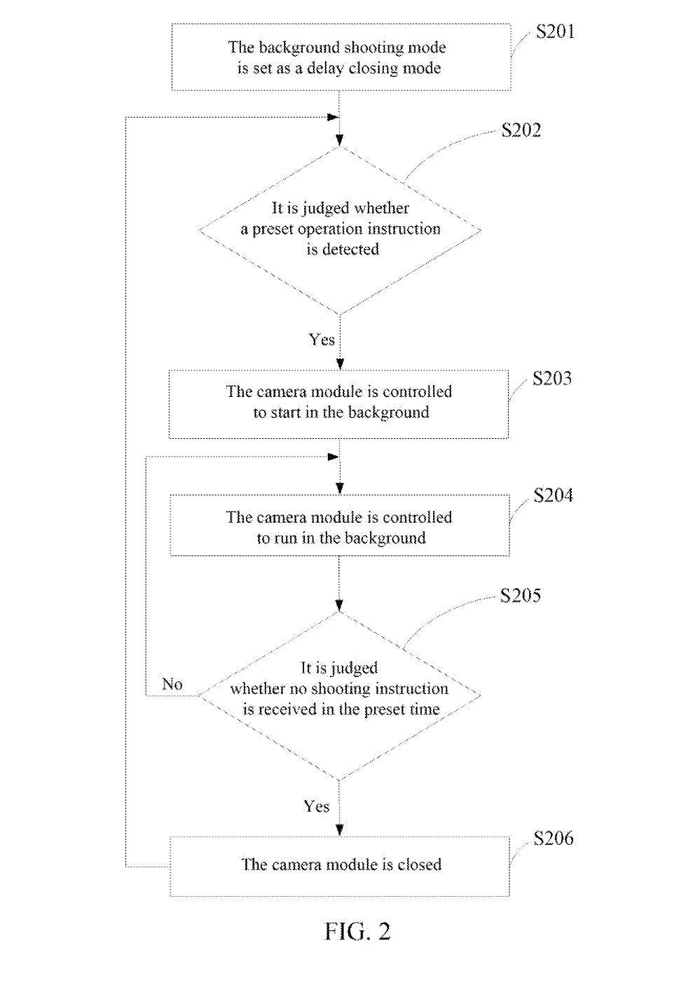

With reference to FIG. 2, a second embodiment of the background shooting method according to the disclosure is proposed. The background shooting method includes the following steps.

In step S201, the background shooting mode is set as a delay closing mode.

In the delay closing mode, a time for delay closing is preset, i.e., how long to close the camera module after completing shooting, which may be set by a user himself/herself.

In step S202, it is judged whether a preset operation instruction is detected.

In step S203, the camera module is controlled to start in the background.

In step S204, the camera module is controlled to run in the background.

The camera module running in the background refers to a process of the camera module performing shooting or waiting for shooting in the background after being started. The entire process is implemented in the background, a current display interface of the shooting apparatus is not occupied, and a user can operate other applications of the shooting apparatus and use other functions at the same time.

In step S205, it is judged whether no shooting instruction is received in the preset time.

After the camera module is started, if no shooting instruction is received over the preset time, or if the camera module is started and then shooting is performed and after shooting is completed, no shooting instruction is received again over the preset time, the process proceeds to step S206. Otherwise, the camera module continues to run in the background, shoot or waits for shooting.

In step S206, the camera module is closed.

When no shooting instruction is received in a long time, in order to save power, the shooting apparatus closes the camera module and the process returns to step S202, i.e., the background service of the shooting apparatus waits for the next shooting, and when an operation instruction is detected, the camera module is started again to perform shooting.

The embodiment is suitable for a scenario where a specific shooting time is not clear and multiple pictures need to be taken during shooting. For example, when actions of some animals are photographed, as a specific shooting time is not known, the only way is to wait. If a user wants to photograph consecutive actions during photographing, the more the pictures required to be taken, the better. At this time, if the camera module is closed when a photograph is taken once, during the next shooting, if the camera module is started again, a certain time may be lost and a snapshot cannot be taken. In the delay closing mode, such condition can be processed well. In the delay closing mode, a time for delay closing is set in advance before shooting; for example, the camera module is set to be closed after no operation for 1 minute. After a photograph starts to be taken, photographing is implemented when all targets to be photographed start to move, and continuous photographing may be implemented. After the targets stop to move, a photograph stops to be taken, and the camera module is in a shooting waiting state. If there is no operation for the camera module for 1 minute, the shooting apparatus closes the camera module and the camera module waits for being started the next time. Thereby, the power consumed by running of the camera module when waiting for shooting for a long time can be omitted.

In the embodiment, the camera module is not closed for each shooting. Instead, it needs to wait for a while to see whether a user continues to perform shooting. Only when the user does not perform shooting in a long time, the camera module is closed, and the camera module is started again during the next shooting. Thereby, the camera module is closed through delay, which not only saves power, but also prevents reduction in the shooting speed due to frequent switching of the camera module, which are both considered to improve users' satisfaction.

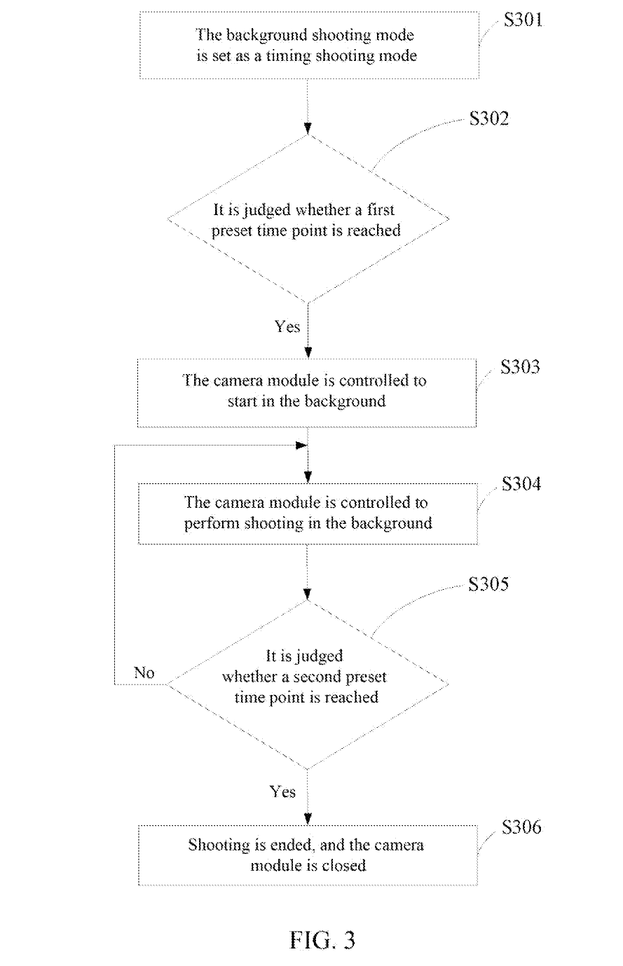

With reference to FIG. 3, a third embodiment of the background shooting method according to the disclosure is proposed. The background shooting method includes the following steps.

In step S301, the background shooting mode is set as a timing shooting mode.

In the timing shooting mode, a user preset a timing time, comprising a first preset time point and a second preset time point, herein the first preset time point is a time point of starting a camera module and the second preset time point is a time point of closing the camera module.

In step S302, it is judged whether the first preset time point is reached.

The shooting apparatus judges whether the first preset time point is currently reached through a timing module, and if so, the process proceeds to step S303; otherwise, no response is made.

In step S303, the camera module is controlled to start in the background.

If the first preset time point is reached, the shooting apparatus starts the camera module in the background.

In step S304, the camera module is controlled to perform shooting in the background.

The shooting may be taking a picture or taking a video. When a picture is taken, a picture may be taken at preset intervals or continuous photographing may be implemented. As the shooting process is implemented in the background, a current display interface of the shooting apparatus is not occupied, and a user can operate other applications of the shooting apparatus and use other functions at the same time.

In step S305, it is judged whether the second preset time point is reached.

The shooting apparatus judges whether the second preset time point is currently reached through the timing module, and if so, the process proceeds to step S306; otherwise, shooting continues to be implemented.

In step S306, shooting is ended, and the camera module is closed.

After the second preset time point is reached, the shooting apparatus ends shooting and closes the camera module.

For an application scenario to which the timing shooting mode is suitable, an accurate shooting time is known, for example, a time for shooting sunrise, shooting various matches etc. By taking the shooting of sunrise as an example, a user knows an approximate time of starting and ending of sunrise. After the timing time is set, the user may use other applications or functions or watch the sunrise on the shooting apparatus. After the first preset time is reached, the shooting apparatus automatically performs shooting in the background, for example, taking a picture at intervals. The user may enter a photo album to watch pictures and issue to others in real time for sharing. After the second preset time is reached, the shooting apparatus ends shooting and closes the camera module.

In the timing shooting process, the camera module automatically performs shooting in the background. The user may view, edit and share the pictures or videos which are taken in real time, or may use other applications or functions of the shooting apparatus, so that the user saves more time and money. At the same time, the camera module is started only when shooting is really needed, and the camera module remains to be closed in other time, which prevents unnecessary electrical energy loss.

In some embodiments, it may only set the first preset time and does not set the second preset time, and the second preset time, i.e., the time of ending shooting, is controlled manually by the user.

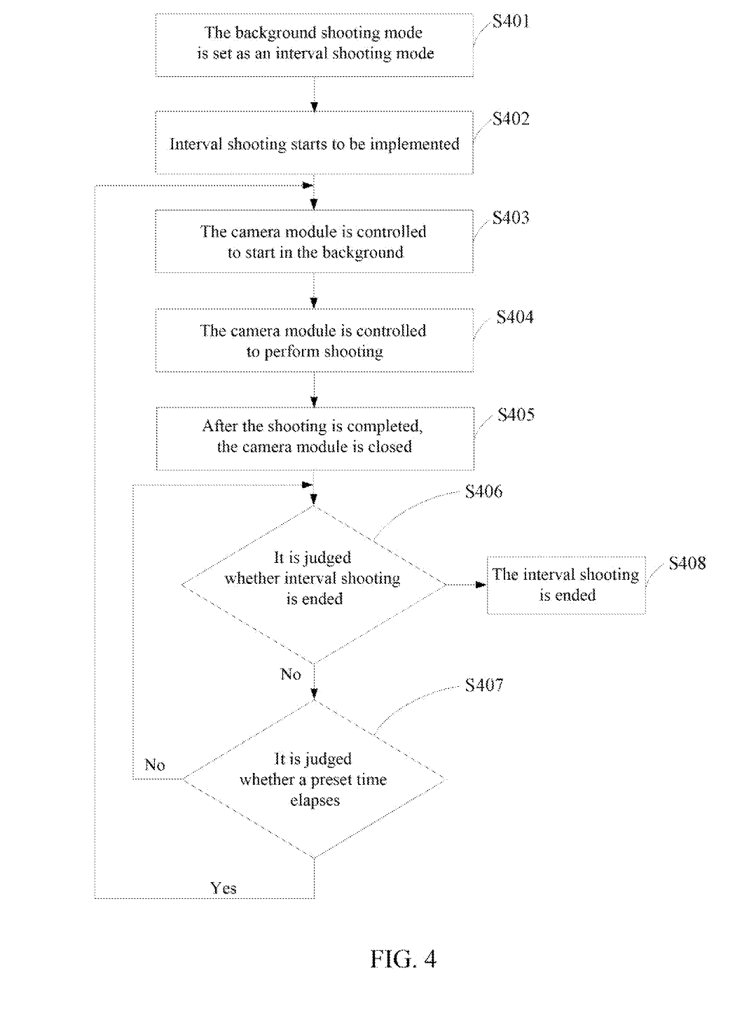

With reference to FIG. 4, a fourth embodiment of the background shooting method according to the disclosure is proposed. The background shooting method includes the following steps.

In step S401, the background shooting mode is set as an interval shooting mode.

In the interval shooting mode, a time interval to the last shooting or the closing of the camera module is preset.

In step S402, interval shooting starts to be implemented.

A time point may be preset. After the time point is reached, interval shooting is automatically started. Alternatively, the user starts the camera module through a functional key or a preset gesture action to start interval shooting.

In step S403, the camera module is controlled to start in the background.

In step S404, the camera module is controlled to perform shooting.

The shooting may be taking a picture or taking a video. When a picture is taken, a picture may be taken at preset intervals or continuous photographing may be implemented. As the shooting process is implemented in the background, a current display interface of the shooting apparatus is not occupied, and a user can operate other applications of the shooting apparatus and use other functions at the same time.

In step S405, after the shooting is completed, the camera module is closed.

After the shooting lasts for a certain time or the number of pictures which are taken reaches a preset number, the shooting is ended, the camera module is closed.

In step S406, it is judged whether interval shooting is ended.

A user may manually control the end of the interval shooting, and the shooting apparatus may also automatically judge whether a condition of ending interval shooting is reached, for example, whether a preset time point or duration of ending interval shooting is reached, or whether a preset number of interval shooting is reached etc. If a judgement result is yes, the process proceeds to step S408; and if the judgement result is no, the process proceeds to step S407.

In step S407, it is judged whether a preset time elapses.

The shooting apparatus judges whether a preset time elapses from the last shooting or the closing of the camera module. If so, the process returns to step S403 to implement the next round of shooting; otherwise, the shooting apparatus continues to wait, herein in the waiting process, it is judged whether the interval shooting is ended.

In step S408, the interval shooting is ended.

In the embodiment, with the preset interval time, after the interval shooting is started, the camera module is automatically started in the background to perform shooting. After the shooting is completed, the camera module is automatically closed again, and after the preset time elapses, the next round of shooting is implemented. The shooting is automatically implemented circularly in such way. In the interval shooting process, a user can view, edit and share pictures or videos in real time, and can also use other applications or functions of the shooting apparatus, so that the user saves more time and money. In addition, in the interval shooting process, the camera module only consumes power during shooting, and does not consume power in the interval time of waiting for shooting due to the closing of the camera module, thereby reducing power consumption.

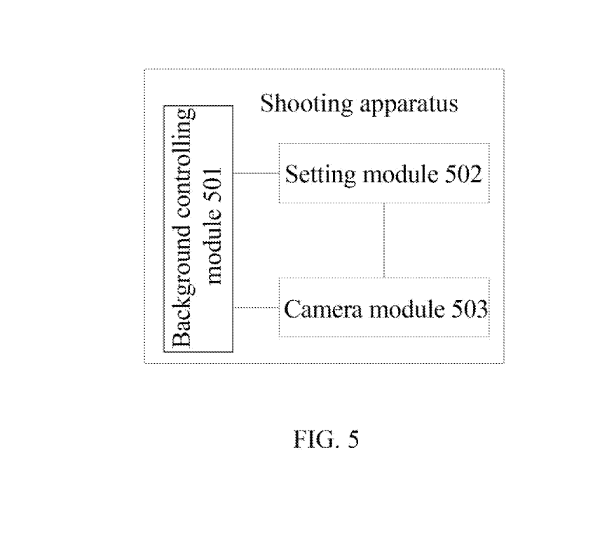

With reference to FIG. 5, an embodiment of a shooting apparatus according to the disclosure is proposed. The shooting apparatus includes a background controlling module 501, a setting module 502 and a camera module 503.

The setting module 502 is arranged to set a background shooting mode. Herein, the background shooting mode includes a power saving preference mode, a delay closing mode, a timing shooting mode, an interval shooting mode etc.

The camera module 503 is arranged to take a picture or video, and perform shooting in the background under the control of the background controlling module.

The background controlling module 501 is arranged to control the camera module to start, run and close in the background according to the background shooting mode.

When the background shooting mode is a power saving preference mode, after detecting a preset operation instruction, the background controlling module controls the camera module to start and run in the background; and after the camera module completes shooting, the background controlling module closes the camera module and waits for an operation instruction for the next shooting.

When the background shooting mode is a delay closing mode, after detecting a preset operation instruction, the background controlling module controls the camera module to start and run in the background; and when detecting that there is no shooting instruction in a preset time, the background controlling module closes the camera module and waits for an operation instruction for the next shooting.

When the background shooting mode is a timing shooting mode, after detecting that a first preset time point is reached, the background controlling module controls the camera module to start and perform shooting in the background; and after detecting that a second preset time point is reached, the background controlling module closes the camera module.

When the background shooting mode is an interval shooting mode, the background controlling module controls the camera module to complete an action of starting, shooting, and closing in the background at preset intervals.

Alternatively,

the background shooting mode is a power saving preference mode, and

the background controlling module is arranged to control the camera module to start, run or close in the background according to the background shooting mode by means of:

after detecting a preset operation instruction, controlling the camera module to start and run in the background; and

once the camera module completes shooting, closing the camera module and starting the camera module again during the next shooting.

Alternatively,

the background shooting mode is a delay closing mode, and

the background controlling module is arranged to control the camera module to start, run or close in the background according to the background shooting mode by means of:

after detecting a preset operation instruction, controlling the camera module to start and run in the background; and

when detecting that there is no shooting instruction in a preset time, closing the camera module.

Alternatively,

the background controlling module is arranged to close the camera module when detecting that there is no shooting instruction in a preset time by means of:

after the camera module is started, if no shooting instruction is received over the preset time, closing the camera module; or

after the camera module completes shooting, if no shooting instruction is received over the preset time, closing the camera module.

Alternatively,

the background shooting mode is a timing shooting mode, and

the background controlling module is arranged to control the camera module to start, run or close in the background according to the background shooting mode by means of:

after detecting that a first preset time point is reached, controlling the camera module to start and perform shooting in the background; and

after detecting that a second preset time point is reached, closing the camera module.

Alternatively,

the background shooting mode is an interval shooting mode, and

the background controlling module is arranged to control the camera module to start, run or close in the background according to the background shooting mode by means of:

controlling the camera module to complete an action of starting, shooting and closing once in the background at preset intervals.

Alternatively, the setting module is further arranged to preset a time interval to the last shooting or the closing of the camera module.

Alternatively, the setting module is further arranged to preset a time point of starting interval shooting; and

the background controlling module is arranged to control the camera module to start interval shooting by: after reaching the time point, controlling the camera module to start interval shooting; or after a user presses down a functional key or after a preset gesture action, controlling the camera module to start interval shooting.

Alternatively, the background controlling module is arranged to control the camera module to end interval shooting by: judging whether a condition of ending interval shooting is reached in the shooting process, and if the condition of ending interval shooting is reached, controlling the camera module to end shooting.

Alternatively, the condition of ending interval shooting refers to that a time point of interval shooting reaches a preset time point or duration of ending interval shooting or a number of interval shooting reaches a preset number of interval shooting.

Alternatively, the background controlling module is arranged to control the camera module to start, run and close in the background by means of:

after controlling the camera module to start in the background, performing shooting or waiting for shooting in the background, herein the entire process of the camera module is implemented in the background, and a current display interface of the shooting apparatus where the camera module is located is not occupied.

A specific flow of the shooting apparatus performing shooting in the background according to the embodiment is as described in the above method embodiments, and the technical features in the above method embodiments are correspondingly suitable in the apparatus, which are not repeated again here.

Thereby, with the shooting apparatus according to the present invention, during background shooting, a camera module can be automatically controlled to start, run and close in the background according to a background shooting mode. As the entire shooting process is automatically implemented, and the camera module runs in the background, a current display interface is not occupied and a user can view, edit and share pictures and videos which are taken in real time, and can also use other applications or functions, so that the user saves more time and money. In addition, the camera module is started or closed by means of various policies to achieve the purpose of saving power, which prevents unnecessary electrical energy loss resulting from the camera module continuously running in the background.

It should be illustrated that when the shooting apparatus provided in the above embodiments performs shooting in the background, it is described by only taking division of the above functional modules as an example. In practical applications, the above functions can be allocated to be completed by different functional modules according to requirements. Further, the shooting apparatus provided in the above embodiments and the background shooting method embodiments belong to the same concept. A specific implementation process thereof can be known with reference to the method embodiment, and will not be described here.

The embodiments of the disclosure disclose a computer program, comprising program instructions, when being implemented by a computer, cause the computer to implement any one of the above background shooting methods.

The embodiments of the disclosure further disclose a carrier having the above computer program carried thereon.

A person having ordinary skill in the art can understand that all or a part of steps in the above embodiment methods can be implemented by controlling related hardware through programs. The programs can be stored in a computer readable storage medium, which may be a ROM/RAM, a disk, a disc etc.

The embodiments of the disclosure are described above with reference to accompanying drawings, and are not used to limit the right range of the present invention. Those skilled in the art can implement the disclosure through many variant solutions without departing from the scope and essence of the disclosure, for example, features of one embodiment can be applied to another embodiment to obtain a further embodiment. Any modification, equivalent substitution and improvement which are made by applying the technical concept of the disclosure should be included in the right scope of the present invention.

### INDUSTRIAL APPLICABILITY

With the background shooting method according to the technical solutions of the disclosure during background shooting, a camera module can be automatically controlled to start, run and close in the background according to a background shooting mode. As the entire shooting process is automatically implemented, and the camera module runs in the background, a current display interface is not occupied and a user can view, edit and share pictures and videos which are taken in real time, and can also use other applications or functions, so that the user saves more time and money. In addition, in the background shooting process, the camera module is started or closed by means of various policies, which prevents unnecessary electrical energy loss resulting from the camera module continuously running in the background, thereby reducing power consumption and saving electrical energy. Therefore, the disclosure has very strong industrial applicability.

1. A background shooting method, comprising steps of:
setting a background shooting mode; and
controlling a camera module to start, run and close in background according to the background shooting mode.

2. The background shooting method according to claim 1, wherein,
the background shooting mode is a power saving preference mode, and
the step of controlling a camera module to start, run or close in background according to the background shooting mode comprises:
after detecting a preset operation instruction, controlling the camera module to start and run in the background;
closing the camera module when the camera module completes shooting; and starting the camera module when shooting again.

3. The background shooting method according to claim 1, wherein,
the background shooting mode is a delay closing mode, and
the step of controlling a camera module to start, run or close in background according to the background shooting mode comprises:
after detecting a preset operation instruction, controlling the camera module to start and run in the background; and
when detecting that there is no shooting instruction in a preset time, closing the camera module.

4. The background shooting method according to claim 3, wherein, the step of when detecting that there is no shooting instruction in a preset time, closing the camera module comprises:
after the camera module is started, if no shooting instruction is received over the preset time, closing the camera module; or
after the camera module completes shooting, if no shooting instruction is received over the preset time, closing the camera module.

5. The background shooting method according to claim 1, wherein,
the background shooting mode is a timing shooting mode, and
the step of controlling a camera module to start, run or close in background according to the background shooting mode comprises:
after detecting that a first preset time point is reached, controlling the camera module to start and perform shooting in the background; and
after detecting that a second preset time point is reached, closing the camera module.

6. The background shooting method according to claim 5, wherein, the first preset time point is a time point of starting the camera module, and the second preset time point is a time point of closing the camera module.

7. The background shooting method according to claim 1, wherein,
the background shooting mode is an interval shooting mode,
the step of controlling a camera module to start, run or close in the background according to the background shooting mode comprises:
controlling the camera module to complete an action of starting, shooting and closing once in the background at preset intervals.

8. The background shooting method according to claim 7, further comprising: presetting a time interval to last shooting or closing of the camera module.

9. The background shooting method according to claim 7, further comprising: presetting a time point, and after reaching the time point, automatically starting interval shooting; or a user starting the camera module by means of a functional key or a preset gesture action to start interval shooting.

10. The background shooting method according to claim 9, further comprising:
judging whether a condition of ending interval shooting is reached in a shooting process, and ending shooting upon the condition of ending interval shooting is reached,
the condition of ending interval shooting refers to that a time point of interval shooting reaches a preset time point or duration of ending interval shooting or the number of interval shooting reaches a preset number of interval shooting.

11. (canceled)

12. The background shooting method according to claim 1, wherein, the step of controlling a camera module to start, run and close in background comprises:
after controlling the camera module to start in the background, performing shooting or waiting for shooting in the background, wherein the entire process of the camera module is implemented in the background, and a current display interface of a shooting apparatus where the camera module is located is not occupied.

13. A shooting apparatus, comprising a setting module, a camera module and a background controlling module, wherein,
the setting module is arranged to set a background shooting mode; and
the background controlling module is arranged to control the camera module to start, run and close in background according to the background shooting mode.

14. The shooting apparatus according to claim 13, wherein,
the background shooting mode is a power saving preference mode, and
the background controlling module is arranged to control the camera module to start, run or close in the background according to the background shooting mode by means of:
after detecting a preset operation instruction, controlling the camera module to start and run in the background; and
once the camera module completes shooting, closing the camera module and starting the camera module again during next shooting.

15. The shooting apparatus according to claim 13, wherein,
the background shooting mode is a delay closing mode, and
the background controlling module is arranged to control the camera module to start, run or close in the background according to the background shooting mode by means of:
after detecting a preset operation instruction, controlling the camera module to start and run in the background; and
when detecting that there is no shooting instruction in a preset time, closing the camera module,
wherein, the background controlling module is arranged to close the camera module when detecting that there is no shooting instruction in a preset time by means of:
after the camera module is started, if no shooting instruction is received over the preset time, closing the camera module; or
after the camera module completes shooting, if no shooting instruction is received over the preset time, closing the camera module.

16. (canceled)

17. The background shooting apparatus according to claim 13, wherein,
the background shooting mode is a timing shooting mode, and
the background controlling module is arranged to control the camera module to start, run or close in the background according to the background shooting mode by means of:
after detecting that a first preset time point is reached, controlling the camera module to start and perform shooting in the background; and
after detecting that a second preset time point is reached, closing the camera module.

18. The background shooting apparatus according to claim 13, wherein,
the background shooting mode is an interval shooting mode, and
the background controlling module is arranged to control the camera module to start, run or close in the background according to the background shooting mode by means of:
controlling the camera module to complete an action of starting, shooting and closing once in the background at preset intervals.

19. The background shooting apparatus according to claim 18, wherein, the setting module is further arranged to preset a time interval to last shooting or closing of the camera module.

20. The background shooting apparatus according to claim 18, wherein,
the setting module is further arranged to preset a time point of starting interval shooting; and
the background controlling module is arranged to control the camera module to start interval shooting by means of: after reaching the time point, controlling the camera module to start interval shooting; or after a user presses down a functional key or after a preset gesture action, controlling the camera module to start interval shooting.

21. The background shooting apparatus according to claim 20, wherein, the background controlling module is arranged to control the camera module to end interval shooting by means of: judging whether a condition of ending interval shooting is reached in a shooting process, and if the condition of ending interval shooting is reached, controlling the camera module to end shooting,
wherein, the condition of ending interval shooting refers to that a time point of interval shooting reaches a preset time point or duration of ending interval shooting or the number of interval shooting reaches a preset number of interval shooting.

22. (canceled)

23. The background shooting apparatus according claim 13, wherein, the background controlling module is arranged to control the camera module to start, run and close in the background by means of:
after controlling the camera module to start in the background, performing shooting or waiting for shooting in the background, wherein the entire process of the camera module is implemented in the background, and a current display interface of the shooting apparatus where the camera module is located is not occupied.
